(19) United States
(12) Patent Application Publication
(10) Pub. No.: US 2004/0128146 A1
(43) Pub. Date: Jul. 1, 2004

(54) AUTOMATED DATA DOCUMENTATION FOR TURBINE MAINTENANCE PROCEDURES

(76) Inventors: George E. Williams, Niskayuna, NY (US); John P. McCarthy, Rochester, NY (US)

Correspondence Address: NIXON & VANDERHYE P.C./G.E., 1100 N. GLEBE RD., SUITE 800, ARLINGTON, VA, 22201, US

(21) Appl. No.: 10/248,213

(22) Filed: Dec. 27, 2002

(51) Int. Cl. G06F 17/60

(52) U.S. Cl. 705/1

(57) ABSTRACT

A programmable computer device is set up to electronically receive data values sent from remote monitoring devices and sensors located at the site of a turbine power generator. The data is transmitted from the site to the receiving computer via the Internet using TCP/IP or UDP protocol. Received data values are incorporated into a database and/or an electronic spreadsheet program running on the computer device. At predetermined stages during the turbine maintenance procedure, data values are transmitted from the site and upon receipt a computer operator at the receiving computer activates a predetermined key or button to automatically enter and time-stamp the received data values into appropriate cells of the electronic spreadsheet or database.

### BACKGROUND OF INVENTION

The present invention relates generally to a method for automatically documenting large quantities of numerical data received electronically from a data source, and more specifically, a method for automatically recording and time-stamping sensor data obtained during the conducting of maintenance procedures on a gas turbine engine.

Whenever maintenance procedures are performed on a turbine engine/generator system, it is highly desirable to accurately record and time-stamp system state information and/or readings from various sensors in the system for future use and evaluation. Conventionally, at least fifty or more data values of different sensor readings must be entered manually into a computer data base or an electronic spreadsheet for each of about eighty or more stages of a typical routine maintenance procedure. For each individual stage of the maintenance procedure, it may take many minutes to manually input, record and time-stamp all of the acquired sensor data values. Because of this lengthy and tedious manual data entry process, the acquired data values are very susceptible to recordation error due to incorrect or incomplete entry. Consequently, the results of any subsequent analysis using that data may be severely compromised.

### SUMMARY OF INVENTION

The present invention provides a computer method and system arrangement for automating the documentation and time-stamping of turbine state information and/or sensor data acquired during the various stages of a turbine maintenance procedure. A programmable computer system or device is equipped to electronically receive data values originating from various monitoring devices and sensors located at the site of a turbine power generator. In the example embodiments described herein, the receiving computer system or device, which may be situated at a location remote from the immediate source of the data values, receives data produced in either a fixed-length static format or a dynamic-length variable format. Preferably, the data is transmitted from the turbine power generator site to the receiving computer system via the Internet using TCP/IP or UDP protocol, although LAN, WAN, conventional landline and/or wireless digital communications links and other transport protocols may also be used.

Upon receipt of turbine state information and/or sensor data, the received data values are asynchronously recorded and time-stamped in appropriate predetermined cells of an electronic spreadsheet or database running on the receiving computer. At predetermined stages during the maintenance procedure, a computer operator manning a conventional I/O interface device at the receiving computer system presses a predetermined keyboard key (or “mouse-clicks” on a display button) to trigger an automated journal of the time-stamped data values for each stage in appropriate predetermined cells of an electronic spreadsheet or database running on the receiving computer. In this manner, multiple data values acquired during each stage of a maintenance procedure are quickly and automatically incorporated into an existing database or an electronic spreadsheet by minimal operator action a single simple action thus precluding many man-minutes of potentially tedious and error-prone manual data-entry operations at each stage.

### BRIEF DESCRIPTION OF DRAWINGS

FIG. 1 is a diagram illustrating data flow in an automated documentation system in accordance with one example of the present invention in which a fixed-length static format data stream is transmitted from a data source;

FIG. 2 is an example software process diagram for implementing automated data documentation on a computer system receiving a fixed-length static format data stream from a remote data source;

FIG. 3 is a diagram illustrating data flow in an automated documentation system in accordance with one example of the present invention in which a dynamic-length variable format data stream is transmitted from a data source and

FIG. 4 is an example software process diagram for implementing an automated data documentation on a computer system receiving a dynamic-length variable format data stream from a remote data source.

### DETAILED DESCRIPTION

A method and arrangement is provided for assisting a computer operator or data entry technician in the task of recording and time-stamping large quantities of numerical data values acquired during the process of performing maintenance procedures on gas turbine power generating equipment and systems. In particular, the process of the present invention may be implemented in software as a computer program product embodied on a computer-readable medium for distribution and/or storage on any computer system that receives a plurality of data values from a data source for entry into a database. By using the software process of the present invention, a plurality of data value readings acquired from sensors and monitoring devices located at an equipment site (i.e., a data source) that are transmitted electronically to a receiving computer system are automatically time-stamped and entered into an existing database or an electronic spreadsheet program that is running on the receiving computer with a minimum of operator intervention or action. The software process of the present invention is initiated by the computer system operator, preferably by a single simple input selection action using a conventional input device, and controls the automatic entry and time-stamping of numerous data values into appropriate database storage locations or worksheet cells thus precluding many man-minutes of error-prone manual data entry.

In one example embodiment of the present invention, an Excel™ Workbook™ application is used on a portable computer device or a remote computer system connected to sensors and monitoring equipment at a remote site via a digital communications link. At predetermined stages during the maintenance procedure, a stream of data values are received by the computer from the remote site and a computer operator activates an input selection device (e.g., uses a mouse to select a predefined software “button” on a display screen or presses a predetermined key on a keyboard) to initiate the software process of the present invention to perform automatic entry and time-stamping of the acquired data values into appropriate worksheet cells. Additionally, the user may initiate other actions such as logging or saving by mouse clicking.

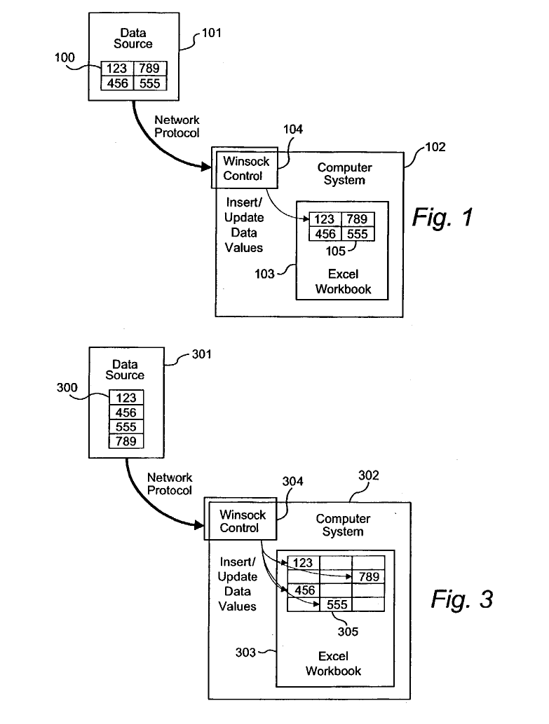

The diagram in FIG. 1 illustrates the general flow and processing of received data in an example embodiment of the present invention in which a fixed-length static format data stream is provided from a data source. Data values 100 are produced by data source 101, which may comprise, for example, one or more monitoring devices and sensors located at the site of a turbine power generator (not shown). In this example, data values 100 originate or are formatted at source 101 as a fixed-length static format stream of digital data. Data source 101 transmits this data stream to a receiving computer system 102 over a digital communications network (not explicitly shown) such as the Internet or, for example, a LAN, WAN, land-line or wireless link. Preferably, the data stream is transmitted using conventional TCP/IP or UDP protocol. Receiving system 102 is connected to the same network and is configured to receive TCP/IP or UDP communications.

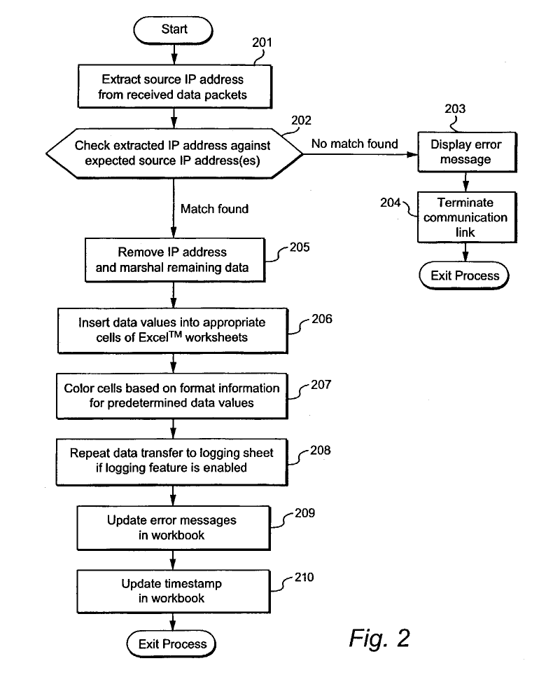

Receiving system 102 may comprise a portable computer device or a remote computer system that is configured with appropriate conventional hardware and software for receiving TCP/IP or UDP communications such as a Winsock™ plug-in component. For this example, receiving system 102 comprises a computing device running an Excel™ Workbook™ application 103 having an embedded Winsock™ control component 104. Upon reception of a TCP/IP or UDP data stream, a software process (FIG. 2) is automatically initiated on receiving system 102. This software process utilizes the Winsock™ control component in conjunction with the Excel™ Workbook™ functions to extract the fixed-length static format stream of data values 100 from received data packets and insert or update the data values in appropriate predetermined cells 105 of an Excel™ worksheet. As part of this process, newly inserted or updated data values 105 are also provided with a time-stamp.

A person of ordinary skill in the related programming arts can appreciate that, in an alternate embodiment, the software processes of the present invention could readily be adapted or modified without undue experimentation so as to operate in conjunction with a particular database or a different proprietary software journal/worksheet arrangement to perform the inserting/updating and time-stamping of the received data as appropriate for the particular database or worksheet operating on computer system 102. Moreover, the present invention may also be implemented using data transport protocols other than TCP/IP or UDP, such as Blue Tooth, WAP, etc.

An example software process diagram for implementing automated data documentation on a computer system that receives data values having a fixed-length static format from a remote data source via the Internet or other TCP/IP or UDP communications network is shown in FIG. 2. The received fixed-length data values are provided to a predetermined labeled range of cells within an Excel™ Workbook™ worksheet that correspond, for example, to specific sensors in a turbine system from which the data is obtained. In this example, upon reception of a TCP/IP or UDP data stream, the software process of FIG. 2 is initiated automatically. At predetermined stages in the maintenance procedure the operator may save or As indicated at block 201, the receiving computer initially extracts a source IP (Internet Protocol) address from received data packets and then checks the extracted IP address for validity by comparing it to a list (stored locally) of predetermined expected source IP addresses, as indicated at block 202. If no match is found for the extracted IP address, a communications error or security error message is produced and the communications link is terminated, as indicated at blocks 203 and 204. If a valid IP source address match is confirmed, the transmitted fixed-length data values are extracted from the received IP encapsulated data packets (e.g., the IP address as well as other miscellaneous TCP/IP or UDP packet header information is removed) and are organized into one or more temporary storage buffers/areas in local memory, as indicated at block 205. Next, as indicated in block 206, the individual stored fixed-length data values are copied from the storage buffers and inserted into appropriate Excel™ Workbook™ worksheet cells.

In addition, as indicated in block 207 of FIG. 2, certain Excel™ Workbook™ worksheet cells may be made to appear a predetermined color based on the format of predetermined data values. Moreover, as indicated in block 208, if a data logging feature is desired and enabled, the data values may also be copied into a Workbook™ logging sheet. Next, any error messages are updated and an updated time-stamp for each data value is created in the Excel™ Workbook™, as indicated in blocks 209 and 210.

The diagram in FIG. 3 illustrates the general flow and processing of a data in an example embodiment of the present invention in which the data stream received from a data source is of dynamic length and variable format. As in the above example of FIG. 1, data source 301 may comprise, for example, one or more monitoring devices and sensors located at the site of a turbine power generator (not shown). However, in this example, data values 300 originate or are formatted at source 301 as a stream of dynamic length and variable format digital data. Preferably, data source 301 transmits this data stream using TCP/IP or UDP protocol over a conventional digital communications network to receiving system 302 which is connected to the same network and is capable of receiving TCP/IP or UDP communications. As in the above FIG. 1 example, receiving system 302 of FIG. 3 may comprise a portable computer device or a remote computer system that is running an Excel™ Workbook™ application 303 having an embedded Winsock™ control component 304.

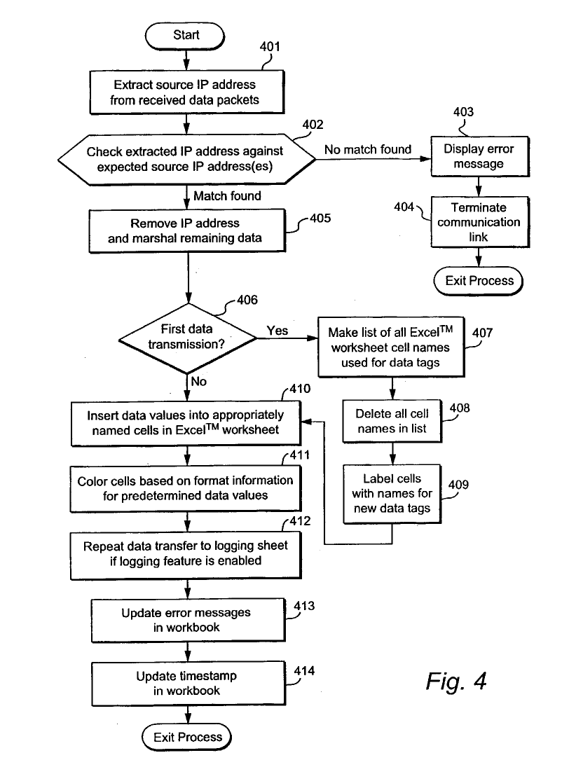

For the dynamic-length variable formatted data stream example of FIG. 3, the software processes of the present invention are illustrated by the flow diagram depicted in FIG. 4. In this example, Winsock™ control component 304 is used in conjunction with Excel™ Workbook™ 303 functions to extract the dynamic-length variable formatted stream of data values 300 from received data packets and insert or update the data values in appropriate predetermined cells 305 of an Excel™ worksheet. As part of this process, newly inserted or updated data values 305 are also provided with a time-stamp.

Referring now to FIG. 4, an example software process diagram for implementing automated data documentation on a computer system that receives a data stream having a dynamic length and variable format from a remote data source via the Internet or other TCP/IP or UDP communications network. As in the previous example discussed above, upon reception of a TCP/IP or UDP data stream, the software process of FIG. 4 is initiated automatically. Received data values are provided to a predetermined labeled range of cells within an Excel™ Workbook™ worksheet that correspond, for example, to specific sensors in a turbine system from which the data is obtained.

As indicated at block 401, the computer initially extracts a source IP address from received data packets and then checks the extracted IP address for validity by comparing it to a predetermined expected source IP address or set of addresses (stored locally), as indicated at block 402. If no match is found for the extracted IP address, a communications error or security error message is produced and the communications link is terminated, as indicated at blocks 403 and 404. If a valid IP source address match is confirmed, the IP address (as well as any other miscellaneous TCP/IP or UDP packet encapsulation data) is removed and the remaining data (i.e., the dynamic-length variable format data values produced by the remote data source) is organized into one or more storage buffers, as indicated at block 405. If the current IP data packet was the first packet transmitted in the transmitted data stream, then before proceeding further with the process at block 410, a list is made of all Excel™ worksheet cell names that are used for data tags, all cell names from the list are deleted, and the worksheet cells are labeled with names for new data tags (blocks 407, 408 and 409). Next, as indicated at block 410, individual data values are copied from the storage buffers and inserted into appropriate Excel™ Workbook™ worksheet cells.

As in the previous example disclosed above, and as indicated at block 411 of FIG. 4, certain Excel™ Workbook™ worksheet cells may be made to appear a predetermined color based on the format of predetermined data values. Moreover, if a data logging feature is desired and enabled, the data values may also be copied into a Workbook™ logging sheet, as indicated at block 412. Finally, any error messages are updated and an updated time-stamp for each data value is created in the Excel™ Workbook™, as indicated at blocks 209 and 210.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims. For example, the present invention may be used to provide automated data documentation for applications other than turbine maintenance procedures and may be implemented using transport protocols other than TCP/IP or UDP, such as, for example, Blue Tooth, WAP, etc.

1. A method for automated documentation of a plurality of digital data values received by a computer from a remote data source, said computer running an Excel™ workbook program arranged to accept and store numerical data values into predetermined worksheet cells, comprising the steps performed by said computer of: a) extracting one or more data values from received data packets;
b) inserting said extracted data values into appropriate cells of one or more Excel™ worksheets; and
c) updating time-stamp information associated with each received data value inserted into a worksheet cell in said Excel™ workbook.

2. The method of claim 1 wherein the computer is connected to the remote data source via a digital communications link that uses TCP/IP or UDP protocol.

3. The method of claim 2, further including the steps of:
extracting a source IP (Internet Protocol) address from one or more received data packets;
comparing an extracted IP address against a list of predetermined IP addresses; and
producing an error notification if the extracted IP address is not identical to an IP address in said list.

4. The method of claim 1 wherein the extracted data values are all of an identical fixed-length and format.

5. The method of claim 1 wherein the extracted data values are of variable length.

6. The method of claim 1 wherein the extracted data values are of variable format.

7. The method of claim 1 wherein the computer includes an input selection device and a plurality of received data values are inserted into cells of one or more Excel™ worksheets in response to a single computer operator input selection activity.

8. The method of claim 1 wherein worksheet cells are color-coded based on predetermined data format designations for predetermined received data values.

9. The method of claim 1 further including the step of entering and/or updating error message information concerning received data in an Excel™ workbook.

10. A computer program product embodied on a computer-readable medium for distribution and/or storage on a computer system for execution to automatically record and time-stamp a plurality of received data values into a database associated with said computer system, comprising:
program instruction means for extracting data values from data packets received from a remote source, said data packets comprising a plurality of data values of fixed-length or variable length format; and
program instruction means for automatically time-stamping and inserting said data values into appropriate storage cells of said database in response to a single operator input selection action.

11. The method of claim 10 further including program instruction means for extracting a source IP (Internet Protocol) address from one or more received data packets, comparing an extracted IP address against a list of predetermined IP addresses and producing an error notification if the extracted IP address is not identical to an IP address in said list.

12. The method of claim 10 wherein the database is implemented on the computer system using an Excel™ workbook program and data values are entered into predetermined worksheet cells.

13. The method of claim 12 including program instruction means for entering and/or updating error message information concerning received data in an Excel™ workbook.

14. The method of claim 12 wherein worksheet cells are color-coded based on predetermined data format designations for predetermined received data values.

15. A method for automating the documentation and time-stamping of turbine state information and/or sensor data acquired during the various stages of a turbine maintenance procedure, comprising the steps, executed by a computer, of:
receiving a stream of data values via a digital communications link;
extracting individual data values from said stream of data values received at said remote computer device, said steam of data values comprising a plurality of data values of fixed-length or variable length format; and
automatically entering a plurality of extracted data values into appropriate storage locations of a database in response to a single operator input selection action.

16. The method of claim 15 further including a step executed by a computer of time-stamping the entry of said extracted data values into the database.

17. The method of claim 15 wherein the database is managed by an Excel™ workbook program running on said computer and extracted data values are entered into appropriate cells of an Excel™ worksheet.
